(19) United States
(12) Patent Application Publication
(10) Pub. No.: US 2022/0004138 A1
(43) Pub. Date: Jan. 6, 2022

(54) CURLING DETECTION DEVICE, IMAGE FORMING APPARATUS, AND CURLING DETECTION METHOD

(71) Applicant: Konica Minolta, Inc., Tokyo (JP)

(72) Inventor: Shunta OKITSU, Aichi (JP)

(21) Appl. No.: 17/368,451

(22) Filed: Jul. 6, 2021

(30) Foreign Application Priority Data
Jul. 6, 2020 (JP) 2020-116607

(51) Int. Cl. G03G 15/00

(52) U.S. Cl. CPC G03G 15/6576; G03G 15/5062

(57) ABSTRACT

A curling detection device including: an imager that captures an image of a sheet conveyed; and a hardware processor that detects an outer shape of the sheet in the image captured by the imager, and evaluates a curling state of the sheet while excluding a portion of the detected outer shape in which a change due to corner folding of the sheet is estimated to have occurred.

### CROSS REFERENCE TO RELATED APPLICATIONS

The present invention claims priority under 35 U.S.C. § 119 to Japanese Patent Application No. 2020-116607 filed on Jul. 6, 2020, which the entire content of which is incorporated herein by reference.

### BACKGROUND

### Technological Field

The present disclosure relates to a curling detection device, an image forming apparatus, and a curling detection method.

### Description of Related Art

An image forming apparatus such as a copying machine, a facsimile, a printer, or a multifunction machine having the functions of the copying machine, facsimile, and printer in combination has a process of transferring an image to a sheet, and fixing the image by applying heat and pressure. In this process, the sheet passes through a transfer drum and/or a fixing device during fixation. At this time, the sheet may curl (i.e., warp of the sheet). The curling occurs owing to a difference in the amount of moisture between the face and back of the sheet caused by heat, pressure, and/or the like of the fixing device, for example. In addition, a sheet to be fed in preparation for image formation may be conveyed in a curled state. The curled sheet deteriorates print quality and/or causes stacking failure, to make it difficult to properly perform post-processing such as subsequent binding processing.

In view of this background, in recent years, an image forming apparatus has been developed which is capable of evaluating the curling state of a sheet and performing processing of correcting the curled sheet or amending image data to be printed on the sheet based on an evaluation result (see, for example, Patent Literature (hereinafter, referred to as “PTL”) 1 (Japanese Patent Application Laid-Open No. 2018-097213).

As this type of image forming apparatus, the prior art according to PTL 1 discloses a method in which a predetermined parameter of a sheet (e.g., an output sheet size, an image for detection of curling, or a contour of an image edge) is extracted from a captured image of a sheet, and the predetermined parameter is compared with a reference value to evaluate the curling state of the sheet.

However, in this type of image forming apparatus, when the sheet is conveyed, corner folding (meaning folding of a sheet that occurs at any of the four corners of the sheet; the same applies hereinafter) may occur in the sheet in addition to curling. As a result of intensive examination by the inventors of the present application, it has been found that in such a case, the conventional method may output an abnormal evaluation result with respect to a curling amount (i.e., the degree of warpage of the sheet) and a curling direction (i.e., the direction of warpage of the sheet).

Note that, in the case where the abnormal evaluation result is output with respect to the curling amount and/or the curling direction, there is a possibility that excessive correction or insufficient correction of the sheet may be performed, for example, when a curling correction device disposed in the image forming apparatus corrects the curled sheet. In other words, in order to properly correct the sheet, it is essential to accurately detect the curling state of the sheet quantitatively.

### SUMMARY

The present disclosure has been made in view of the above problem, and aims to provide a curling detection device, an image forming apparatus, and a curling detection method which enable accurate evaluation of a curling state of a sheet even when corner folding occurs in the sheet.

Principally, the present disclosure that solves the aforementioned problem is a curling detection device including:

an imager that captures an image of a sheet conveyed; and

a hardware processor that detects an outer shape of the sheet in the image captured by the imager, and evaluates a curling state of the sheet while excluding a portion of the detected outer shape in which a change due to corner folding of the sheet is estimated to have occurred.

Further, in another aspect, the present disclosure is

an image forming apparatus including the above-described curling detection device.

Further, in still another aspect, the present disclosure is a curling detection method including:

a first process of capturing an image of a sheet conveyed; and

a second process of detecting an outer shape of the sheet in the image captured in the first process, and evaluating a curling state of the sheet while excluding a portion of the detected outer shape in which a change due to corner folding of the sheet is estimated to have occurred.

### BRIEF DESCRIPTION OF DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates an example of an overall configuration of an image forming apparatus according to Embodiment 1;

FIG. 2 illustrates an example of the overall configuration of the image forming apparatus according to Embodiment 1;

FIG. 3A and FIG. 3B illustrate an example of a configuration of a curling detection device according to Embodiment 1;

FIG. 4 illustrates an image of an entire sheet read by a CCD camera of the curling detection device according to Embodiment 1;

FIG. 5 illustrates an example of the configuration of the curling correction device according to Embodiment 1;

FIG. 6 illustrates an example of a read image of a sheet with upward curling that is captured by the CCD camera;

FIG. 7A illustrates an example of a read image of a sheet generated by the CCD camera in a case where upward curling occurs in an edge region of the sheet and corner folding further occurs in the edge region;

FIG. 7B illustrates an example of a read image of a sheet generated by the CCD camera in a case where downward curling occurs in an edge region of the sheet and corner folding further occurs in the edge region;

FIG. 8 illustrates a more preferable configuration of the curling detection device;

FIG. 9 illustrates an example of operation of the curling detection device according to Embodiment 1;

FIG. 10 is an explanatory view for explaining a curling evaluation method for a sheet in a curling detection device according to Embodiment 2;

FIG. 11 illustrates an example of operation of the curling detection device according to Embodiment 2;

FIG. 12 is an explanatory view for explaining a curling evaluation method for a sheet in a curling detection device according to Embodiment 3; and

FIG. 13 illustrates an example of operation of the curling detection device according to Embodiment 3.

### DETAILED DESCRIPTION OF EMBODIMENTS

Hereinafter, one or more embodiments of the present invention will be described with reference to the drawings. However, the scope of the invention is not limited to the disclosed embodiments.

Note that, in the present specification and drawings, components having substantially the same functional structures are provided with the same reference symbols, and redundant description will be omitted.

### Embodiment 1

### [Configuration of Image Forming Apparatus]

To begin with, an image forming apparatus according to the present embodiment will be described. The image forming apparatus according to the present embodiment is applied to a copying machine, a printer, a facsimile machine, or the like.

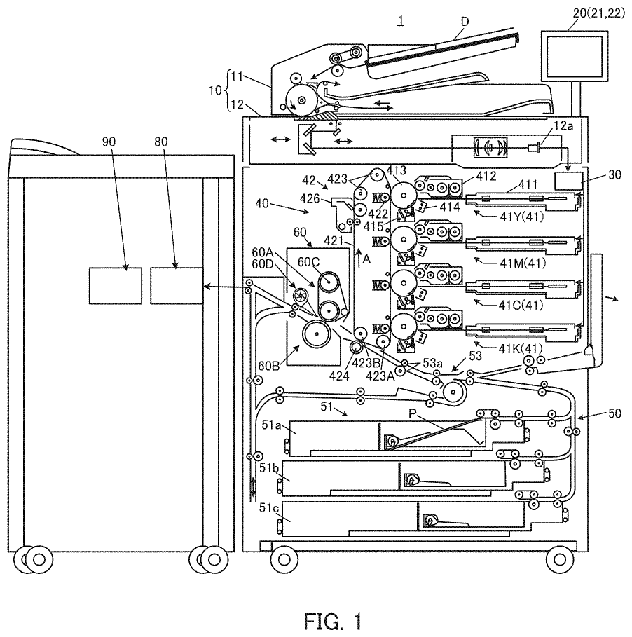

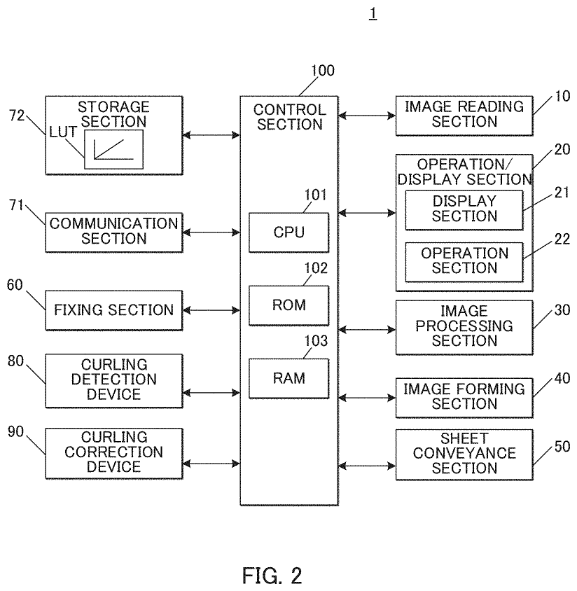

FIG. 1 and FIG. 2 illustrate an example of the overall configuration of image forming apparatus 1.

Image forming apparatus 1 illustrated in FIG. 1 is a color image forming apparatus of an intermediate transfer system using electrophotographic process technology. That is, image forming apparatus 1 transfers (primary-transfers) toner images of yellow (Y), magenta (M), cyan (C), and black (K) formed on photoconductor drums 413 to intermediate transfer belt 421, and superimposes the toner images of the four colors on one another on intermediate transfer belt 421. Then, image forming apparatus 1 secondary-transfers the resultant image to sheet P, thereby forming a toner image.

A longitudinal tandem system is adopted for image forming apparatus 1. In the longitudinal tandem system, respective photoconductor drums 413 corresponding to the four colors of YMCK are placed in series in the travelling direction of intermediate transfer belt 421, and the toner images of the four colors are sequentially transferred to intermediate transfer belt 421 in one cycle.

As illustrated in FIG. 2, image forming apparatus 1 includes image reading section 10, operation/display section 20, image processing section 30, image forming section 40, sheet conveyance section 50, fixing section 60, communication section 71, storage section 72, curling detection device 80, curling correction device 90, control section 100, and the like.

Control section 100 is configured to include central processing unit (CPU) 101, read only memory (ROM) 102, random access memory (RAM) 103 and the like. In control section 100, CPU 101 reads a program suited to processing contents from ROM 102, loads the program into RAM 103, and integrally controls an operation of each block of image forming apparatus 1 in cooperation with the loaded program. At this time, CPU 101 refers to various kinds of data stored in storage section 72. Storage section 72 is composed of, for example, a non-volatile semiconductor memory (so-called flash memory) or a hard disk drive. However, it is needless to say that each function of control section 100 is not limited to processing by software, and may also be implemented by a dedicated hardware circuit.

Control section 100 transmits and receives various data to and from an external apparatus (for example, a personal computer) connected to a communication network such as a local area network (LAN) or a wide area network (WAN), through communication section 71. Control section 100 receives, for example, image data transmitted from the external apparatus, and performs control to form a toner image on sheet P based on this image data (input image data). Communication section 71 is composed of, for example, a communication control card such as a LAN card.

Image reading section 10 includes auto document feeder (ADF) 11, document image scanning device 12 (scanner), and the like.

Auto document feeder 11 conveys, with a conveyance mechanism, document D placed on a document tray, to send out document D to document image scanner 12. Auto document feeder 11 is capable of successively reading at once images (even both sides thereof) of a large number of documents D placed on the document tray.

Document image scanner 12 optically scans a document conveyed from auto document feeder 11 onto a contact glass or a document placed on the contact glass, and images reflected light from the document on a light receiving surface of charge coupled device (CCD) sensor 12a to read the document image. Image reading section 10 generates input image data based on a result read by document image scanner 12. The input image data undergoes predetermined image processing in image processing section 30.

Operation/display section 20 includes, for example, a liquid crystal display (LCD) provided with a touch panel, and functions as display section 21 and operation section 22. Display section 21 displays various operation screens, image conditions, operating statuses of each function, and/or the like in accordance with display control signals input by control section 100. Operation section 22 equipped with various operation keys, such as a numeric keypad and a start key, receives various input operations by users and outputs operation signals to control section 100.

Image processing section 30 includes a circuit and/or the like that performs digital image processing of input image data in accordance with default settings or user settings. For example, image processing section 30 performs correction processing on the input image data based on color correction data (Lookup table (LUT)) in storage section 72. Based on the color correction data, image processing section 30 performs various types of correction processing, such as gradation correction, color correction, and shading correction, compression processing, and the like, on the input image data, for example. Image forming section 40 is controlled based on the image data that has been subjected to these processes.

Image forming section 40 includes: image forming units 41Y, 41M, 41C, and 41K that form images of colored toners of a Y component, an M component, a C component, and a K component based on the input image data; intermediate transfer unit 42; and the like.

Image forming units 41Y, 41M, 41C, and 41K for the Y component, the M component, the C component, and the K component have similar configurations. For convenience in illustration and description, common elements are denoted by the same reference signs and such reference signs are accompanied by Y, M, C, or K when they are to be distinguished. In FIG. 1, reference signs are given to only the elements of image forming unit 41Y for the Y component, and reference signs are omitted for the elements of other image forming units 41M, 41C, and 41K.

Each of image forming units 41 includes exposing device 411, developing device 412, photoconductor drum 413, charging device 414, drum cleaning device 415 and the like.

Photoconductor drum 413 is a negative-charging type organic photoconductor (OPC) formed by sequentially laminating an undercoat layer (UCL), a charge generation layer (CGL), and charge transport layer (CTL) on a peripheral surface of a conductive cylindrical body made of aluminum (aluminum pipe as a raw material), for example. The charge generation layer is formed of an organic semiconductor in which a charge generation material (e.g., a phthalocyanine pigment) is dispersed in a resin binder (e.g., polycarbonate), and generates a pair of positive and negative charges by exposure by exposing device 411. The charge transport layer is formed of a hole transport material (an electron-donating nitrogen-containing compound) dispersed in a resin binder (e.g., a polycarbonate resin), and transports positive charges generated in the charge generation layer to the surface of the charge transport layer.

Control section 100 causes photoconductor drum 413 to rotate at a constant peripheral velocity by control of a driving current supplied to a driving motor (not illustrated) that causes photoconductor drum 413 to rotate.

Charging device 414 negatively charges the surface of photoconductive photoconductor drum 413 uniformly. Exposing device 411 is composed of, for example, a semiconductor laser, and configured to irradiate photoconductor drum 413 with laser light corresponding to the image of each color component. Positive charges are generated in the charge generation layer of photoconductor drum 413 and transported to the surface of the charge transport layer, whereby the surface charges (negative charges) of photoconductor drum 413 are neutralized. Electrostatic latent images of respective color components are formed on the surface of photoconductor drum 413 due to potential differences from the surroundings.

Developing device 412 is a developing device, for example, of a two-component developing system, and attaches a toner of each color component to the surface of photoconductor drum 413 to visualize the electrostatic latent image to form a toner image.

Drum cleaning device 415 includes a drum cleaning blade that is brought into sliding contact with the surface of photoconductor drum 413, and removes transfer residual toner that remains on the surface of photoconductor drum 413 after the primary transfer.

Intermediate transfer unit 42 includes intermediate transfer belt 421 as an image bearing member, primary transfer rollers 422, a plurality of support rollers 423, secondary transfer roller 424, belt cleaning device 426, and the like.

Intermediate transfer belt 421 is composed of an endless belt, and is wound under tension around the plurality of support rollers 423 in a loop form. At least one of the plurality of support rollers 423 is composed of a driving roller, and the others are each composed of a driven roller. For example, it is preferable that roller 423A disposed on the downstream side in the belt travelling direction relative to primary transfer roller 422 for the K component be the driving roller. This makes it easier to keep constant the travelling speed of the belt in a primary transfer part. Intermediate transfer belt 421 travels in direction of arrow A at a constant speed by rotation of driving roller 423A.

Primary transfer rollers 422 are disposed on the inner peripheral surface side of intermediate transfer belt 421 to face photoconductor drums 413 of respective color components. Primary transfer rollers 422 are brought into pressure contact with photoconductor drums 413 with intermediate transfer belt 421 therebetween, whereby a primary transfer nip for transferring toner images from photoconductor drums 413 to intermediate transfer belt 421 is formed.

Secondary transfer roller 424 is disposed to face backup roller 423B disposed on the downstream side in the belt travelling direction relative to driving roller 423A, at a position on the outer peripheral surface side of intermediate transfer belt 421. Secondary transfer roller 424 is brought into pressure contact with backup roller 423B with intermediate transfer belt 421 therebetween, whereby a secondary transfer nip for transferring toner images from intermediate transfer belt 421 to sheet P is formed.

When intermediate transfer belt 421 passes through the primary transfer nip, the toner images on photoconductor drums 413 are sequentially primary-transferred to intermediate transfer belt 421 in a layered manner. To be more specific, a primary transfer bias is applied to primary transfer rollers 422, and an electric charge of the polarity opposite to the polarity of the toner is applied to the rear surface side (the side of intermediate transfer belt 421 that makes contact with primary transfer rollers 422), whereby the toner images are electrostatically transferred to intermediate transfer belt 421.

Thereafter, when sheet P passes through the secondary transfer nip, the toner images on intermediate transfer belt 421 are secondary-transferred to sheet P. To be more specific, a secondary transfer bias is applied to secondary transfer roller 424, and an electric charge of the polarity opposite to the polarity of the toner is applied to the rear surface side of sheet P (the side of sheet P that makes contact with secondary transfer roller 424), whereby the toner images are electrostatically transferred to sheet P. Sheet P to which the toner images have been transferred is conveyed towards fixing section 60.

Belt cleaning section 426 has a belt cleaning blade or the like that makes sliding contact with the surface of intermediate transfer belt 421, and removes transfer residual toner remaining on the surface of intermediate transfer belt 421 after the secondary transfer. Note that, instead of secondary transfer roller 424, a configuration in which a secondary transfer belt is wound under tension around a plurality of support rollers including a secondary transfer roller in a loop form (a so-called belt type secondary transfer unit) may be employed.

Fixing section 60 includes upper fixing section 60A having a fixing-surface-side member disposed on a fixing surface side of sheet P (on the surface side of sheet P on which a toner image is formed), lower fixing section 60B having a rear-surface-side supporting member disposed on the rear surface side of sheet P (on the surface side of sheet P opposite to the fixing surface), heating source 60C, and the like. The rear-surface-side supporting member is brought into pressure contact with the fixing-surface-side member, whereby a fixing nip for conveying sheet P in a tightly sandwiching manner is formed.

At the fixing nip, fixing section 60 applies heat and pressure to sheet P on which the toner images have been secondary-transferred and which has been conveyed to the fixing nip, so as to fix the toner images on sheet P. Further, air separating section 60D for separating sheet P from the fixing-surface-side member by blowing air is disposed in fixing section 60.

Sheet conveyance section 50 includes sheet feeding section 51, conveyance path section 53, and the like. Three sheet feeding tray units 51a to 51c, which constitute sheet feeding section 51, store sheets P classified based on basis weight, size, or the like (standard paper, special paper) in accordance with predetermined types. Conveyance path section 53 includes a plurality of conveyance roller pairs, such as registration roller pairs 53a.

Sheets P stored in sheet feeding tray units 51a to 51c are sent out one by one from the top one and conveyed to image forming section 40 through conveyance path section 53. At this time, a registration roller section in which registration roller pairs 53a are arranged corrects skew of sheet P fed thereto, and adjusts the conveyance timing. Then, in image forming section 40, toner images on intermediate transfer belt 421 are secondary-transferred to one side of sheet P at one time, and a fixing process is performed in fixing section 60.

Sheet P on which an image has been formed is conveyed to curling detection device 80 and curling correction device 90 disposed as post-processing devices (FNS). After the curling state is evaluated and corrected by these devices, sheet P is discharged to the outside of image forming apparatus 1.

Note that, the post-processing devices (FNS) may have a post-processing section for predetermined processing such as stapling, punching, center-folding, bookbinding, or the like.

[Configuration of Curling Detection Device and Curling Correction Device]

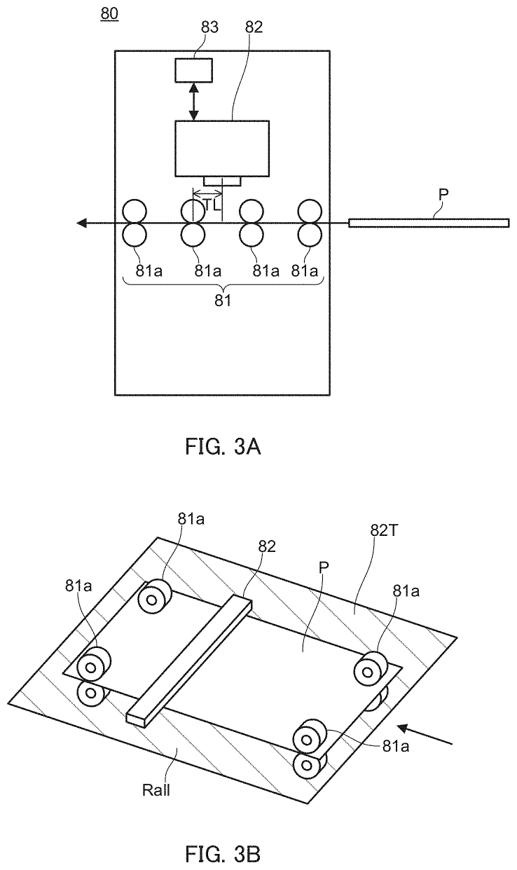

FIGS. 3A-FIG. 3B illustrate an example of the configuration of curling detection device 80. FIG. 3A is a side view of curling detection device 80, and FIG. 3B is a perspective view of curling detection device 80.

Curling detection device 80 includes conveyance section 81, CCD camera 82, and curling evaluation section 83.

Conveyance section 81 forms a part of sheet conveyance section 50, receives from fixing section 60 sheet P on which an image has been formed by image forming section 40 and on which the image has been fixed by fixing section 60, and conveys sheet P toward curling correction device 90. Conveyance section 81 includes conveyance rollers 81a disposed at predetermined intervals. Sheet P is conveyed by conveyance rollers 81a from the upstream side toward the downstream side while being pressed from above and below. For example, conveyance rollers 81a as seen in plan view are disposed on the both sides of CCD camera 82 in the conveyance direction at positions that do not overlap with CCD camera 82.

CCD camera 82 (corresponding to the “imager” of the present invention) captures an image of sheet P from the upper surface side or the lower surface side of sheet P conveyed by conveyance section 81. CCD camera 82 is disposed linearly along the width direction of sheet P (a direction orthogonal to the conveyance direction of conveyance section 81; the same applies hereinafter). CCD camera 82 captures an image of entire sheet P by capturing an image of sheet P at each position, for example, during when sheet P is conveyed from the upstream side toward the downstream side.

CCD camera 82 has a length exceeding the width of sheet P, and can detect the outer shape of sheet P from the images generated by CCD camera 82. Note that, in order to easily detect the outer shape of sheet P from the images generated by CCD camera 82, black background plate 82T is disposed on the opposite side of CCD camera 82.

Curling evaluation section 83 evaluates the curling state of sheet P using the images of sheet P captured by CCD camera 82. Curling evaluation section 83 is a microcomputer configured to include, for example, CPU, ROM, RAM, an input port, an output port, and the like. Curling evaluation section 83 may be implemented as a part of the functions of control section 100 that performs overall control of image forming apparatus 1.

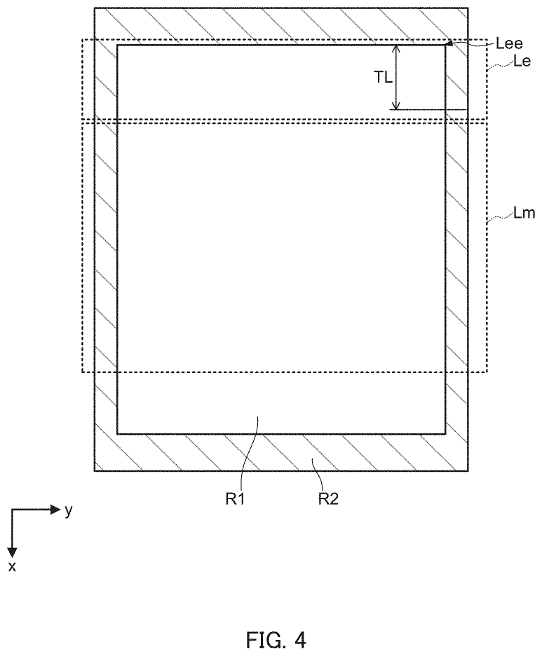

FIG. 4 illustrates an image of entire sheet P read by CCD camera 82 of curling detection device 80.

FIG. 4 illustrates the image of entire sheet P in a case where neither curling nor corner folding occur in sheet P. Note that, the image of FIG. 4 is generated, for example, from images captured at positions by CCD camera 82 and superimposed in curling evaluation section 83. In FIG. 4, white region R1 represents a sheet region, and black region R2 represents a background region. In addition, in FIG. 4, the upper direction of the sheet corresponds to the conveyance direction of sheet P, and the lateral direction of the sheet corresponds to the width direction of sheet P.

Note that, in the present embodiment, positions in the image generated by CCD camera 82 are represented by an xy coordinate system of x and y coordinates orthogonal to each other. Here, the direction in which sheet P is conveyed is represented by the −x direction, and the right side of the sheet in the width direction of sheet P is represented by the +y direction.

In curling detection device 80 according to the present embodiment, the curling state of sheet P is evaluated based on images generated by CCD camera 82 when edge region Le of sheet P on the downstream side in the conveyance direction is present at a position immediately in front of a position where edge region Le reaches those of conveyance rollers 81a adjacent to CCD camera 82 at the downstream side. This is because, when sheet P is present at such a position, warpage of sheet P due to curling is not regulated by conveyance rollers 81a, and the curling state of sheet P can be appropriately evaluated.

Note that, the distance between CCD camera 82 and those of conveyance rollers 81a adjacent to CCD camera 82 at the downstream side (distance TL illustrated in FIG. 3A and FIG. 4) is set to an appropriate distance such that the curling state of sheet P can be detected. In the following, a range of sheet P extending from downstream edge end Lee of sheet P to the middle side of sheet P and corresponding to this distance between CCD camera 82 and those of conveyance rollers 81a adjacent to CCD camera 82 at the downstream side is also referred to as “curling region TL” to mean a region in which curling may occur in sheet P.

Note that, in the following, for convenience of explanation, the downstream edge end of sheet P in the conveyance direction is referred to as “edge end Lee of sheet P.” Further, a region of sheet P on the upstream edge end Lee side in the conveyance direction is referred to as “edge region of sheet P” (region Le in FIG. 4), and a region of sheet P on the middle side of edge region Le of sheet P when sheet P is seen along the conveyance direction is referred to as “middle region of sheet P” (region Lm in FIG. 4).

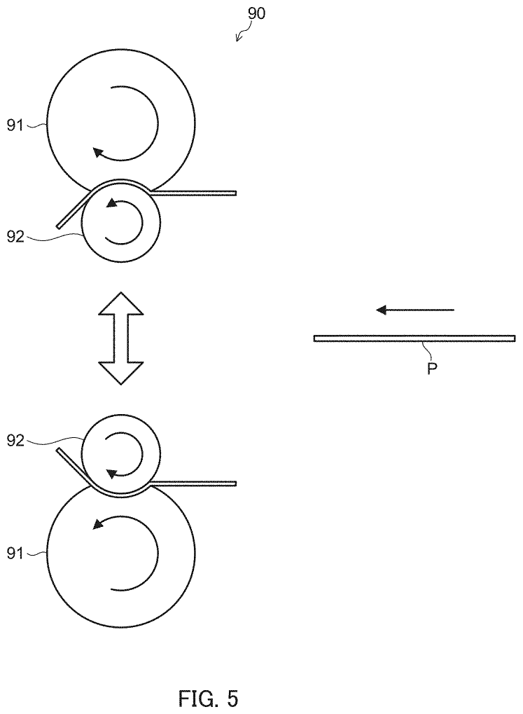

FIG. 5 illustrates an example of the configuration of curling correction device 90.

In curling correction device 90, the curling state occurring in sheet P conveyed from curling detection device 80 is corrected by bringing first correction roller 91 and second correction roller 92 disposed to face each other in the vertical direction into pressure contact with sheet P from above and below. Curling correction device 90 is capable, for example, of switching the vertical arrangements of first correction roller 91 and second correction roller 92, and dealing with curling in upward and downward curling directions by the switching of the vertical arrangements. Curling correction device 90 is capable of adjusting a curling correction amount by changing a contact position between first correction roller 91 and second correction roller 92.

The operation of curling correction device 90 is typically set based on the curling amount and curling direction of sheet P detected by curling detection device 80.

[Evaluation Method of Evaluating Curling State]

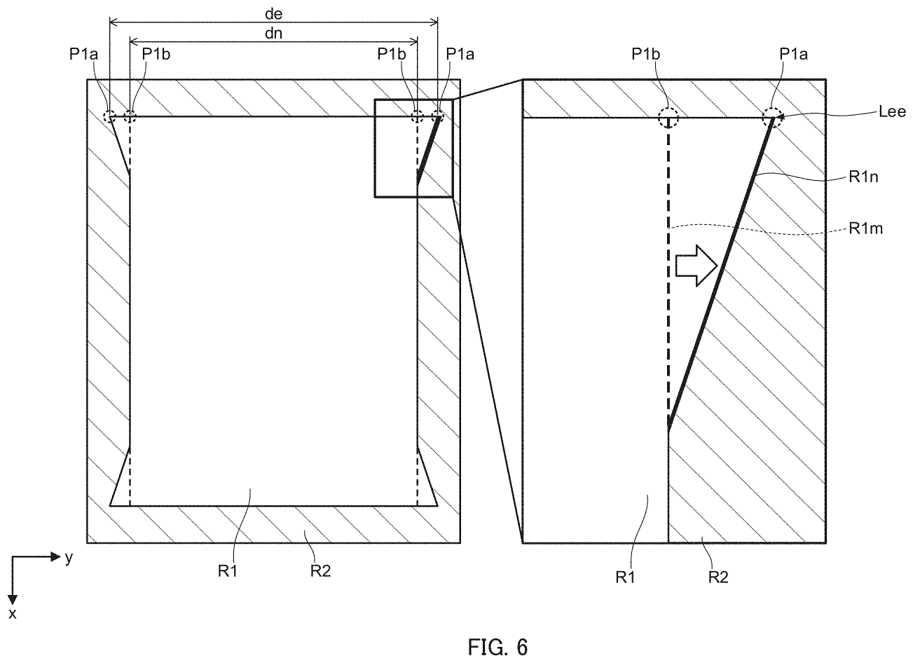

Hereinafter, an evaluation method of evaluating the curling state of sheet P performed by curling detection device 80 (curling evaluation section 83) according to the present embodiment will be described with reference to FIG. 6 to FIG. 8.

To begin with, the evaluation method of evaluating the curling state of sheet P in a case where no corner folding occurs in sheet P will be described.

FIG. 6 illustrates an example of an image of sheet P having upward curling that is obtained by capturing with CCD camera 82, which is hereinafter referred to as “read image.” The right diagram in FIG. 6 is an enlarged view illustrating an image of edge region Le of sheet P at a position boxed by a square in the left diagram in FIG. 6. Note that, in FIG. 6, boundary line R1n of a solid line represents the actual outer shape of sheet P detected from the read image, and boundary line R1m of a dotted line represents the reference outer shape of sheet P (the outer shape of sheet P in a state where neither curling nor corner folding occur).

When upward curling (which means curling toward the CCD camera 82 side with respect to the sheet surface of sheet P; the same applies hereinafter) occurs in sheet P, edge region Le of sheet P is closer to CCD camera 82 than middle region Lm of sheet P is to CCD camera 82. Accordingly, in the read image, edge region Le of sheet P is enlarged in the width direction in comparison to middle region Lm of sheet P as illustrated in FIG. 6. Further, at this time, in edge region Le of sheet P, the distance between sheet P and CCD camera 82 decreases toward edge end Lee of sheet P from middle region Lm. Thus, in the read image, the width of sheet P in edge region Le (which represents the size of sheet P in the direction orthogonal to the conveyance direction; the same applies hereinafter) increases toward edge end Lee of sheet P from middle region Lm of sheet P.

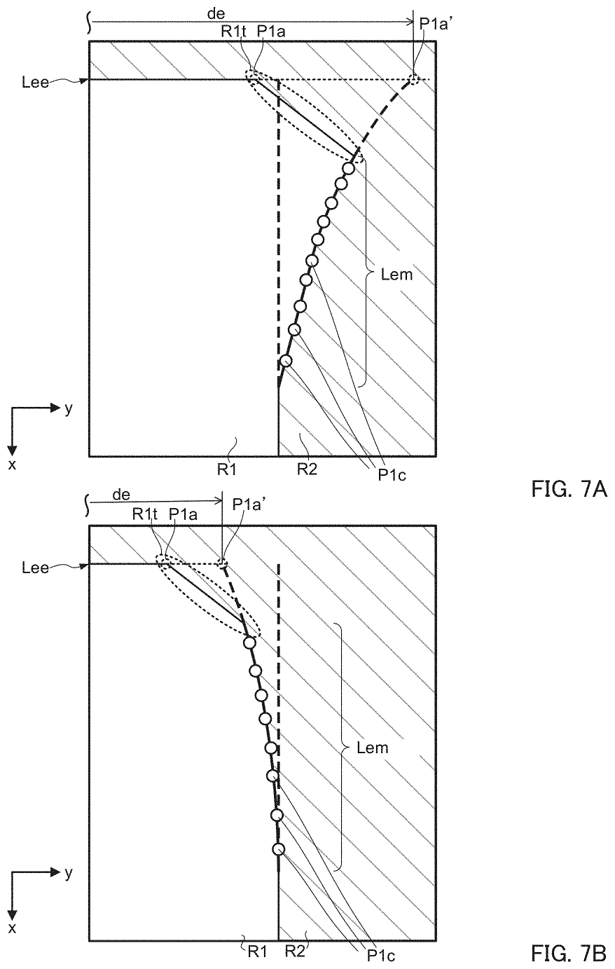

On the other hand, when downward curling (which means curling toward the side opposite to CCD camera 82 with respect to the sheet surface of sheet P; the same applies hereinafter) occurs in sheet P, edge region Le of sheet P is farther from CCD camera 82 than middle region Lm of sheet P is from CCD camera 82. Accordingly, in such a case, an image of edge region Le of sheet P is captured such that the edge region appears to be reduced in size in the width direction in comparison to middle region Lm of sheet P in the read image (see FIG. 7B to be described later). Further, at this time, in edge region Le of sheet P, the distance between sheet P and CCD camera 82 increases toward edge end Lee of sheet P from middle region Lm. Thus, in the read image, the width of sheet P in edge region Le (which represents the size of sheet P in the direction orthogonal to the conveyance direction; the same applies hereinafter) decreases toward edge end Lee of sheet P from middle region Lm of sheet P.

From this viewpoint, curling evaluation section 83 detects the outer shape of sheet P, for example, from the read image. Then, curling evaluation section 83 evaluates the curling state of sheet P by comparing the width of sheet P in edge region Le obtained from the detected outer shape of sheet P with the reference width of sheet P in edge region Le in a case where no curling occurs. Here, curling evaluation section 83 evaluates the curling state of sheet P based on the width of sheet P at edge end Lee in edge region Le, and curling evaluation section 83 evaluates the curling state of sheet P based on, for example, the ratio between the width of sheet P at edge end Lee obtained from the detected outer shape of sheet P (hereinafter, also referred to as “evaluation-target width de”) and the reference width of sheet P at edge end Lee in the case where no curling occurs (hereinafter, also referred to simply as “reference width dn”).

Specifically, curling evaluation section 83 first detects the outer shape of sheet P by comparing a tonal value of each pixel in the read image with a predetermined threshold, for example. Here, for example, (the maximum tonal value+the minimum tonal value)/2, where the maximum and minimum tonal values are detected in the read image, a predetermined specific value, or the like is set as the predetermined threshold. Note that, at this time, curling evaluation section 83 may detect the outer shape of sheet P from the tonal change of pixels adjacent to one another in the read image.

Next, for example, curling evaluation section 83 compares outer shape R1n of edge region Le of detected sheet P with reference outer shape R1m of edge region Le of sheet P in the case where no curling occurs, and determines whether outer shape R1n of edge region Le of detected sheet P is enlarged or reduced with respect to reference outer shape R1m of edge region Le of sheet P in the case where no curling occurs. Thus, it is identified whether the curling direction of the curling occurring in evaluation-target sheet P is the upward direction or the downward direction. Note here that, when outer shape R1n of edge region Le of detected sheet P overlaps with reference outer shape R1m of edge region Le of sheet P in the case where no curling occurs, curling evaluation section 83 identifies that no curling occurs in evaluation-target sheet P.

Next, curling evaluation section 83 evaluates the curling amount based on, for example, the ratio between width de of evaluation-target sheet P at edge end Lee and reference width dn of sheet P at edge end Lee (=de/dn). Note here that, curling evaluation section 83 may evaluate the curling amount based on the difference (=de−dn) between width de of evaluation-target sheet P at edge end Lee and reference width dn of sheet P at edge end Lee.

Note that, when the curling state is evaluated, curling evaluation section 83 estimates reference outer shape R1m and reference width dn of sheet P from the outer shape of sheet P in middle region Lm detected in the read image, for example. Since middle region Lm of sheet P is pressed from above and below by conveyance rollers 81a of conveyance section 81, the outer shape of middle region Lm of sheet P does not change within the read image even when curling occurs in edge region Le of sheet P. Since the shape of sheet P is grasped in advance (typically, a rectangular shape), curling evaluation section 83 can draw, based on the read image, reference outer shape R1m of sheet P in the case where neither curling nor corner folding occur. Thus, curling evaluation section 83 can estimate reference width do of sheet P at edge end Lee as the distance between vertices P1b of reference outer shape R1m.

Next, the evaluation method of evaluating the curling state of sheet P in a case where corner folding occurs in sheet P will be described.

FIG. 7A illustrates an example of a read image of sheet P generated by CCD camera 82 in a case where upward curling (here, curling toward the CCD camera 82 side) occurs in edge region Le of sheet P and, further, corner folding occurs in said edge region Le.

FIG. 7B illustrates an example of a read image of sheet P generated by CCD camera 82 in a case where downward curling (here, curling toward the side opposite to CCD camera 82) occurs in edge region Le of sheet P and, further, corner folding occurs in said edge region Le.

Note that FIG. 7A and FIG. 7B are enlarged views illustrating only edge region Le of sheet P. In FIG. 7A and FIG. 7B, region R1t circled by a dotted line is a part of the read image at which the outer shape of sheet P changes due to the influence of the corner folding of sheet P.

Regarding the outer shape of sheet P appearing in the read image, when corner folding occurs in sheet P, the part corresponding to the corner folding does not appear in the read image as illustrated in FIG. 7A and FIG. 7B, and the outer shape of sheet P appearing in the read image changes into such a shape as that having chipped edge region Le.

Specifically, when upward curling occurs in edge region Le of sheet P and, further, corner folding occurs in said edge region Le, the width of sheet P in edge region Le increases toward edge end Lee of sheet P from middle region Lm of sheet P due to the influence of the curling, and then gradually decreases due to the influence of the corner folding in the read image as illustrated in FIG. 7A. In other words, in the read image, the inclination direction of edge region Le of sheet P with respect to the minus x direction that is affected by the corner folding is opposite to the inclination direction of edge region Le of sheet P with respect to the minus x direction that is affected by the curling.

On the other hand, when downward curling occurs in edge region Le of sheet P and, further, corner folding occurs in said edge region Le, the width of sheet P in edge region Le, for example, decreases toward edge end Lee of sheet P from middle region Lm of sheet P due to the influence of the curling, and then further decreases due to the influence of the corner folding in the read image as illustrated in FIG. 7B. Note that, in the read image, a chipped portion of edge region Le of sheet P in the image due to the influence of the corner folding is larger than a chipped portion of edge region Le of sheet P in the image due to the influence of the curling. In other words, in the read image, the inclination angle of the outer shape of edge region Le of sheet P with respect to the minus x direction that is affected by the corner folding is larger than the inclination angle of the outer shape of edge region Le of sheet P with respect to the minus x direction that is affected by the curling.

As is understood, in order to accurately evaluate the curling state of sheet P when the corner folding occurs in sheet P, it is necessary to set evaluation-target width de to be compared with reference width dn, in which the influence of a shape change in the outer shape of sheet P due to the corner folding is excluded (that is, it is necessary to set evaluation-target width de while estimating the shape change in the outer shape of sheet P only due to the curling).

From this viewpoint, curling evaluation section 83 first determines whether or not there is corner folding in edge region Le of sheet P based on the outer shape of edge region Le of sheet P detected from the read image. Then, when corner folding has occurred in sheet P, curling evaluation section 83 sets an analysis point on a side of the outer shape of edge region Le of detected sheet P extending along the conveyance direction and in the region not including the shape change due to the corner folding, and estimates, based on the coordinates of the analysis point, the outer shape of edge region Le of sheet P on the assumption that no shape change due to the corner folding of sheet P is included, so as to set evaluation-target width de to be compared with reference width dn.

Specifically, for example, curling evaluation section 83 determines whether or not the outer shape of edge region Le of sheet P detected from the read image has undergone a shape change as in FIG. 7A or FIG. 7B, thereby determining whether or not there is corner folding in edge region Le of sheet P.

At this time, curling evaluation section 83, for example, searches each point on the side of the outer shape of edge region Le of sheet P extending along the conveyance direction, and determines, based on a positional deviation direction and a positional deviation amount of sheet P in the width direction between successive search points, whether or not corner folding has occurred. For example, when the positional deviation direction of sheet P deviating in the width direction between successive search points is initially in the enlargement direction (+y direction) as seen from the middle region Lm side of sheet P toward edge end Lee (in the −x direction) and changes into the reduction direction (−y direction) along the way, curling evaluation section 83 determines that both the upward curling and the corner folding have occurred in edge region Le of sheet P. Alternatively, for example, when the positional deviation direction of sheet P in the width direction between successive search points is only in the reduction direction (−y direction) as seen from the middle region Lm side of sheet P toward edge end Lee (in the −x direction) and the positional deviation amount (that is, the change in the inclination angle of the outer shape of sheet P) comes to exceed a predetermined threshold along the way, curling evaluation section 83 determines that both the downward curling and the corner folding have occurred in edge region Le of sheet P.

When it is determined that sheet P does not have corner folding in this determination process determining as to whether there is corner folding, curling evaluation section 83 performs evaluation of the curling state as usual.

On the other hand, when it is determined that sheet P has corner folding in this determination process determining as to whether there is corner folding, curling evaluation section 83 sets a plurality of analysis points (points Plc in FIG. 7A and FIG. 7B) in a region (region Lem in FIG. 7A and FIG. 7B) of edge region Le of the outer shape of detected sheet P where there is no shape change due to the corner folding. Based on the coordinates of the plurality of analysis points Plc, curling evaluation section 83 expresses, by an approximate expression, the outer shape of edge region Le of sheet P on the assumption that a shape change only due to the curling occurs. Here, the outer shape of edge region Le of sheet P in the case where the shape change due to the curling occurs can be approximated by, for example, a quadratic curve in both the cases of upward curling and downward curling.

For example, the outer shape of edge region Le of sheet P in the case where the shape change due to curling occurs is expressed by the approximate expression of the quadratic curve: y=αx²+βx+γ. At this time, letting the coordinates of analysis points Plc set in the region where there is no shape change due to corner folding be (xₖ, yₖ), and the reference number of analysis points Plc ben, factors α, β, and γ of the approximate expression are expressed as in following Equation 1. Factors α, β, and γ can be optimized using, for example, the least squares method.

$$\begin{matrix}[ 1 ] & \\ ( \begin{matrix}α \\ β \\ γ\end{matrix} ) ( \begin{matrix}{\sum }_{k = 1} \text{?} {x}_{k}^{4} & {\sum }_{k = 1} \text{?} {x}_{k}^{3} & {\sum }_{k = 1} \text{?} {x}_{k}^{2} \\ {\sum }_{k = 1} \text{?} {x}_{k}^{3} & {\sum }_{k = 1} \text{?} {x}_{k}^{2} & {\sum }_{k = 1} \text{?} {x}_{k}^{ } \\ {\sum }_{k = 1} \text{?} {x}_{k}^{2} & {\sum }_{k = 1} \text{?} {x}_{k}^{ } & {\sum }_{k = 1} \text{?} 1\end{matrix} ) ( \begin{matrix}{\sum }_{k = 1} \text{?} {x}_{k}^{2} {y}_{k} \\ {\sum }_{k = 1} \text{?} {x}_{k}^{ } {y}_{k} \\ {\sum }_{k = 1} \text{?} {y}_{k}\end{matrix} ) \\ \text{?} \text{indicates text missing or illegible when filed} & ( Equation 1 )\end{matrix}$$

Curling evaluation section 83 thus calculates, by the quadratic curve expression, the outer shape of edge region Le of sheet P in the region where the shape change only due to the curling has occurred. Then, curling evaluation section 83 extends the approximated quadratic curve expression to the x-coordinate position of edge end Lee of sheet P, to estimate the coordinates of vertex position P1a′ of edge end Lee of sheet P on the assumption that a shape change only due to the curling has occurred. Note that, in FIG. 7A and FIG. 7B, point P1a′ corresponds to the estimated vertex position of edge end Lee of sheet P on the assumption that a shape change only due to curling occurs.

With reference to estimated vertex position P1a′ of edge region Le of sheet P calculated as described above, curling evaluation section 83 estimates width de of sheet P at edge end Lee on the assumption that a shape change only due to curling occurs, and sets this estimated width de as evaluation-target width de to be compared with reference width dn. Then, curling evaluation section 83 evaluates the curling amount of sheet P using the ratio (=de/dn) or the difference (=de−dn) between evaluation-target width de and reference width dn as an index in the same manner as in the case where there is no corner folding in sheet P.

Curling evaluation section 83 determines a curling correction operation of curling correction device 90 based on an evaluation result on the curling state of sheet P evaluated as described above (that is, based on the curling amount and the curling direction of sheet P). At this time, for example, curling evaluation section 83 determines the vertical arrangement of first correction roller 91 and second correction roller 92 of curling correction device 90 so as to correct the curling direction of sheet P, and adjusts the pressing amount of first correction roller 91 and second correction roller 92 pressing sheet P correspondingly to the curling amount of sheet P. Note that the operation of curling correction device 90 is associated in advance with the curling amount and the curling direction of sheet P as control data, for example, and curling evaluation section 83 determines the operation of curling correction device 90 based on the control data.

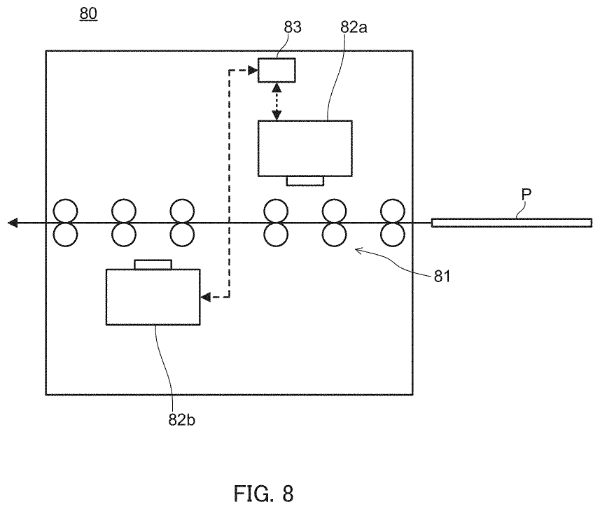

FIG. 8 illustrates a more preferable configuration of curling detection device 80.

Curling detection device 80 illustrated in FIG. 3 has the configuration in which CCD camera 82 captures an image of only the upper surface side of sheet P, but curling detection device 80 illustrated in FIG. 8 has a configuration in which upper-surface image capturing CCD camera 82a and lower-surface image capturing CCD camera 82b are disposed to be capable of capturing images of the upper surface side and the lower surface side of sheet P separately.

In such an embodiment, curling evaluation section 83 detects the outer shape of sheet P from each of the upper-surface-side read image of sheet P generated by upper-surface image capturing CCD camera 82a and the lower-surface-side read image of sheet P generated by lower-surface image capturing CCD camera 82b, and selects, as an image to be used for evaluation, one of the upper-surface-side read image of sheet P and the lower-surface-side read image of sheet P in which the outer shape of detected sheet P in edge region Le has a tendency to be enlarged in comparison to the reference outer shape of sheet P.

As can be seen from FIG. 7A and FIG. 7B, when determining whether or not there is corner folding in sheet P, it is possible to perform the determination more accurately by using the captured image (FIG. 7A) of the state in which edge region Le of sheet P curls in a direction approaching CCD camera 82 than by using the captured image (FIG. 7B) of the state in which edge region Le of sheet P curls in a direction away from CCD camera 82.

Accordingly, it is possible to evaluate the curling state of sheet P more correctly and accurately with the configuration as illustrated in FIG. 8 in which the images of the upper surface side and the lower surface side of sheet P are separately captured by upper-surface image capturing CCD camera 82a and lower-surface image capturing CCD camera 82b, and the captured image of the state in which edge region Le of sheet P curls in the direction approaching CCD camera 82 (upper-surface image capturing CCD camera 82a or lower-surface image capturing CCD camera 82b) is selected by curling evaluation section 83 as an image used to evaluate the curling state.

Note that, the configuration for capturing the image of each of the upper surface side and the lower surface side of sheet P may be achieved by an aspect in which a turnover path for turning over sheet P is incorporated in conveyance section 81 and images of both of the upper surface side and the lower surface side of sheet P are captured by single CCD camera 82, instead of the aspect in which upper-surface image capturing CCD camera 82a and lower-surface image capturing CCD camera 82b are prepared as illustrated in FIG. 8.

[Operation of Curling Detection Device]

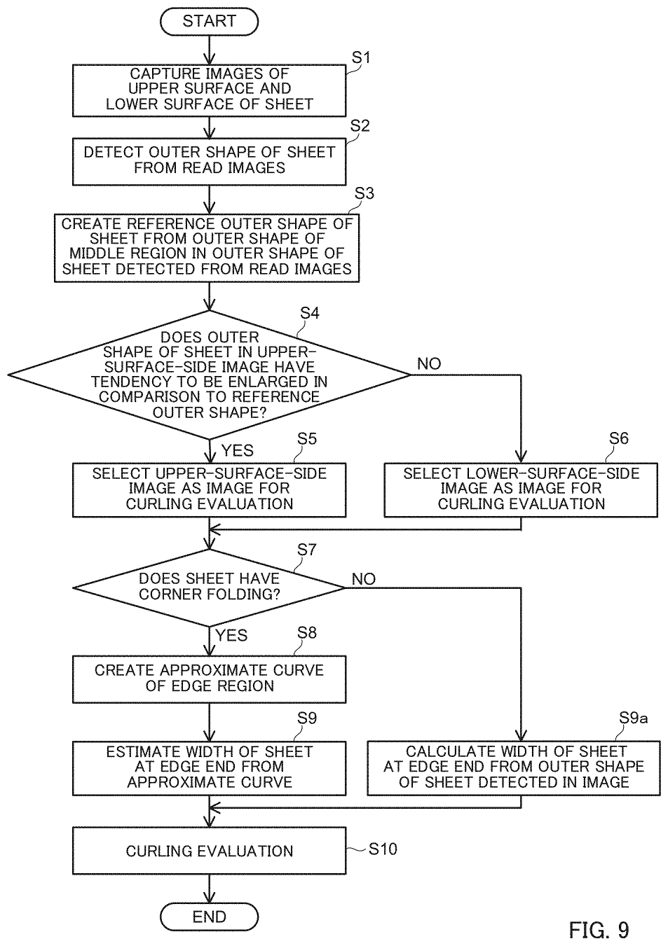

FIG. 9 illustrates an example of the operation of curling detection device 80 according to the present embodiment. The flowchart of FIG. 9 represents a process executed by curling evaluation section 83 for each conveyed sheet P in accordance with a computer program, for example. Note here that, the operation of curling evaluation section 83 in the aspect where upper-surface image capturing CCD camera 82a and lower-surface image capturing CCD camera 82b are disposed as in FIG. 8 is illustrated.

At step S1, curling evaluation section 83 causes upper-surface image capturing CCD camera 82a to capture an image of the upper surface of sheet P and causes lower-surface image capturing CCD camera 82b to capture an image of the lower surface of sheet P, and obtains information on the upper-surface-side read image and the lower-surface-side read image of sheet P from these images.

At step S2, curling evaluation section 83 detects the outer shape of sheet P from each of the upper-surface-side read image and the lower-surface-side read image of sheet P.

At step S3, curling evaluation section 83 creates, based on the outer shape of middle region Lm of sheet P detected at step S2, a reference outer shape of sheet P in a state where neither curling nor corner folding occur in sheet P, and obtains reference width do of sheet P in edge region Le (here, edge end Lee) based on the reference outer shape of sheet P.

Note that, at this time, curling evaluation section 83 may create the reference outer shape of sheet P for each of the outer shape of sheet P detected from the upper-surface-side read image of sheet P and the outer shape of sheet P detected from the lower-surface-side read image of sheet P, or may create the reference outer shape of sheet P only for the outer shape of sheet P detected from either the upper-surface-side read image or the lower-surface-side read image of sheet P.

At step S4, curling evaluation section 83 compares the outer shape of edge region Le of sheet P detected at step S2 with the reference outer shape of sheet P created at step S3, to determine whether or not the outer shape of sheet P detected at step S2 is larger than the reference outer shape of sheet P.

Note that, at this time, curling evaluation section 83 may perform the determination processing on each of the outer shape of sheet P detected from the upper-surface-side read image of sheet P and the outer shape of sheet P detected from the lower-surface-side read image of sheet P, or only on the outer shape of sheet P detected from either the upper-surface-side read image or the lower-surface-side read image of sheet P.

Here, when the outer shape of edge region Le of sheet P detected at step S2 is larger than the reference outer shape of sheet P (step S4: YES), curling evaluation section 83 proceeds to step S5, and when the outer shape of edge region Le of sheet P detected at step S2 is not larger than the reference outer shape of sheet P (step S4: NO), curling evaluation section 83 proceeds to step S6.

At step S5, curling evaluation section 83 selects the upper-surface-side read image of sheet P as an image to be used for evaluating the curling state of sheet P. On the other hand, at step S6, curling evaluation section 83 selects the lower-surface-side read image of sheet P as an image to be used for evaluating the curling state of sheet P.

At step S7, curling evaluation section 83 determines whether or not sheet P has corner folding by using the image selected at step S5 or step S6. Here, when curling evaluation section 83 determines that sheet P has corner folding (step S7: YES), the process proceeds to step S8. On the other hand, when it is determined that there is no corner folding in sheet P (step S7: NO), curling evaluation section 83 skips to step S9a.

Note that, at this step S7, curling evaluation section 83 determines, for example, whether or not the outer shape of edge region Le of sheet P detected from the read image has undergone a shape change as in FIG. 7A, so as to determine whether or not there is corner folding in sheet P.

At step S8, in order to obtain width de of sheet P at edge end Lee on the assumption that a shape change only due to the curling has occurred, curling evaluation section 83 sets a plurality of analysis points Plc in a region of curling region TL of sheet P except for a corner-folding portion. Based on the coordinates of the plurality of analysis points Plc, curling evaluation section 83 creates an approximate curve defining the outer shape of sheet P on the assumption that a shape change only due to the curling has occurred.

At step S9, curling evaluation section 83 estimates vertex position P1a′ of edge end Lee of sheet P based on the approximate curve created at step S8, and estimates, based on the coordinates of vertex position P1a′, width de of sheet P at edge end Lee on the assumption that a shape change only due to the curling has occurred.

At step 59a, curling evaluation section 83 calculates width de of sheet P at edge end Lee based on the outer shape of sheet P detected in the image (here, the image selected at step S5 or step S6).

At step S10, curling evaluation section 83 evaluates the curling amount of sheet P by comparing width de of sheet P at edge end Lee with reference width do of sheet P at edge end Lee.

Note that, at this step S10, when there is no corner folding in sheet P, curling evaluation section 83 evaluates the curling amount of sheet P based on, for example, the ratio between width de of edge end Lee of the outer shape of sheet P obtained at step S9a and reference width dn of sheet P at edge end Lee. On the other hand, when sheet P has corner folding, curling evaluation section 83 evaluates the curling amount of sheet P based on the ratio between, on one hand, width de of edge end Lee of the outer shape of sheet P on the assumption that a shape change only due to the curling estimated at step S9 has occurred and, on the other hand, reference width dn of sheet P at edge end Lee.

Curling evaluation section 83 executes the above-described process, for example, for each sheet P to be conveyed. Then, curling evaluation section 83 operates, for example, curling correction device 90 based on the evaluation result on the curling state of sheet P, to perform correction processing on sheet P.

### Effect

As described above, curling detection device 80 according to the present embodiment includes: an imager (CCD camera 82 of the above-described embodiment) that captures the image of sheet P conveyed by conveyance section 81; and curling evaluation section 83 that detects the outer shape of sheet P in the image captured by the imager, and evaluates the curling state of sheet P while excluding a portion of the detected outer shape which is estimated to have a change due to corner folding of sheet P.

It is thus possible to accurately evaluate the curling state (the curling direction, the curling amount, and the like) of sheet P even when corner folding occurs in sheet P. It is thus possible, for example, to perform appropriate correction processing according to the curling state of sheet P.

### Embodiment 2

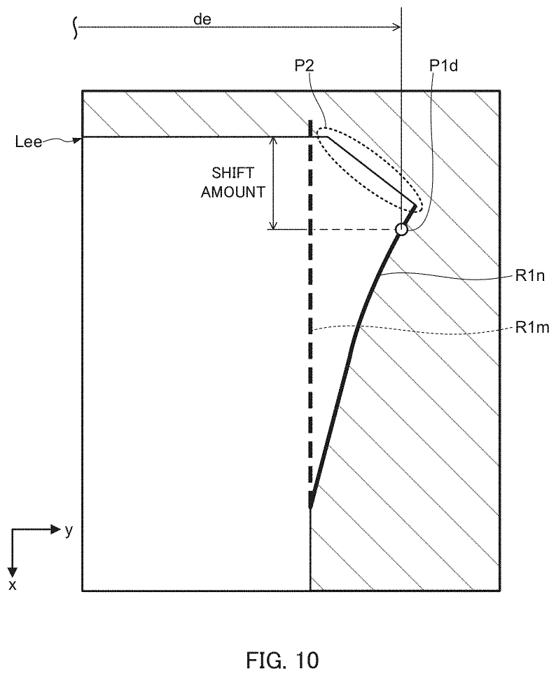

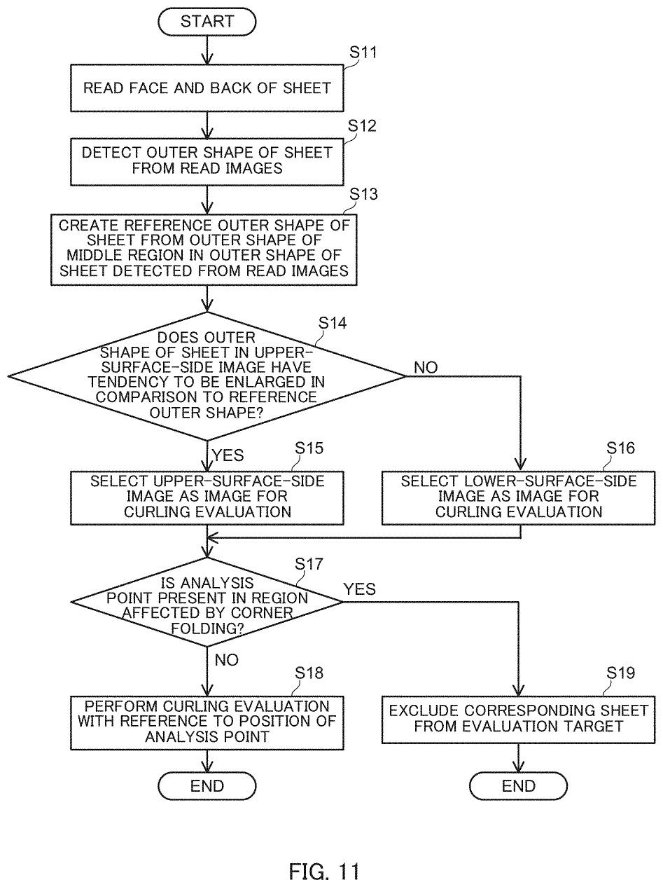

Next, a configuration of curling detection device 80 according to Embodiment 2 will be described with reference to FIG. 10 and FIG. 11.

Curling detection device 80 according to the present embodiment differs from curling detection device 80 according to Embodiment 1 in the curling evaluation method for sheet P. Note that, the description of the configurations the same between Embodiment 1 and the present embodiment is omitted.

FIG. 10 is an explanatory view for explaining the curling evaluation method for sheet P in curling detection device 80 according to the present embodiment. In FIG. 10, for convenience of explanation, the same read image as FIG. 7A is illustrated.

In the curling evaluation method for sheet P according to the present embodiment, it is assumed in advance that sheet P has corner folding. Regardless of whether or not sheet P actually has corner folding, an analysis point (point P1d in FIG. 10) is set in a read image on the side of the outer shape of sheet P extending along the conveyance direction and in a region estimated not to include a shape change due to corner folding of sheet P. The width (de in FIG. 10) of the outer shape of sheet P at the coordinate of analysis point P1d in the conveyance direction serving as a reference position is set as an evaluation-target width. It is thus possible to evaluate the curling state of sheet P without an influence of corner folding even if the corner folding occurs in sheet P. It is thus possible to evaluate the curling state of sheet P more easily.

Specifically, without performing the determination processing on all evaluation-target sheets P as to whether or not sheets P have corner folding, curling evaluation section 83 according to the present embodiment sets analysis point P1d to a position that is located on the side of edge region Le of the outer shape of sheet P extending along the conveyance direction and that is shifted by a predetermined amount from edge end Lee of sheet P toward the middle region Lm side. Then, evaluation-target width de is obtained based on the coordinate of analysis point P1d in the width direction of sheet P (for example, a value obtained by doubling the Y coordinate of analysis point P1d is evaluation-target width de when the coordinate system is such that the center position of sheet P in the width direction is the origin in the ±Y direction). Then, curling evaluation section 83 according to the present embodiment evaluates the curling amount based on the ratio between evaluation-target width de obtained as described above and reference width dn.

Here, the shift amount (that is, the position at which analysis point P1d is set) from edge end Lee of sheet P is set to be equal to or greater than the distance from edge end Lee of sheet P to a corner folding point on sheet P supposed when sheet P has the corner folding, and is set to be equal to or less than the distance of curling region TL (that is, edge region Le) such that analysis point P1d is located within curling region TL. The shift amount to be used may be a value set in advance through experiments or simulations, or a value set by a user. In addition, the shift amount may be set to be equal to or greater than the number of pixels that cannot be used for detection of corner folding based on the resolution of the read image.

However, the greater the shift amount is set, the smaller the shape change of sheet P due to curling becomes. Accordingly, the accuracy of evaluation of the curling state of sheet P deteriorates. It is thus preferable to set the shift amount as small as possible within a range in which sheet P does not include corner folding.

Note that, reference width dn of sheet P in edge region Le may be obtained based on the reference outer shape of sheet P using the coordinate of analysis point P1d in the conveyance direction as the reference position, or the width obtained from the outer shape of sheet P in middle region Lm detected in the read image may be used as reference width dn.

Note that, in the curling evaluation method according to the present embodiment, when the corner folding occurring in sheet P is large, analysis point P1d is set to a position affected by the shape change due to the corner folding. Thus, the curling state cannot be appropriately evaluated. Therefore, based on the shape of edge region Le in the outer shape, it may be determined whether or not the position of analysis point P1d corresponds to the position affected by the shape change due to corner folding, and when the position of analysis point P1d corresponds to the position affected by the shape change due to the corner folding, sheet P may be excluded from the evaluation target.

FIG. 11 illustrates an example of the operation of curling detection device 80 according to the present embodiment. Note that, steps S11 to S16 are the same processes as steps S1 to S6 described above, and therefore description thereof is omitted.

At step S17, curling evaluation section 83 sets analysis point P1d on the side of edge region Le of the outer shape of sheet P extending along the conveyance direction. Then, curling evaluation section 83 determines whether or not the position of analysis point P1d (i.e., the shift position) corresponds to the position affected by a shape change due to corner folding in the image. Here, curling evaluation section 83 proceeds to step S18 when the position of analysis point P1d does not correspond to the position affected by the shape change due to corner folding (step S17: NO) in the image. On the other hand, when the position of analysis point P1d corresponds to the position affected by the shape change due to the corner folding (step S17: YES) in the image, curling evaluation section 83 proceeds to step S19 and excludes sheet P from the evaluation target.

At step S18, curling evaluation section 83 obtains, from the coordinate of analysis point P1d in the width direction of sheet P, evaluation-target width de to be compared with reference width dn. Then, curling evaluation section 83 evaluates the curling amount based on the ratio between evaluation-target width de thus obtained and reference width dn of sheet P in edge region Le.

As described above, according to curling detection device 80 of the present embodiment, even when a shape change due to corner folding occurs, it is possible to evaluate the curling state of sheet P by a simpler method while reducing the influence of the shape change.

### Embodiment 3

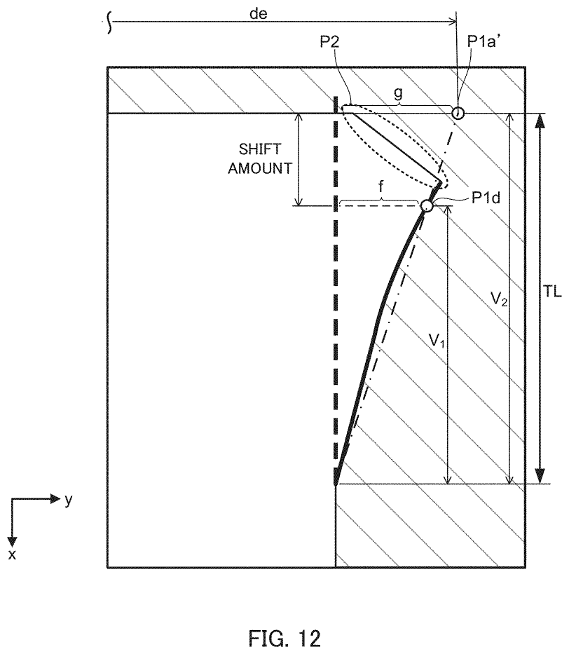

Next, with reference to FIG. 12, the configuration of curling detection device 80 according to Embodiment 3 will be described.

Curling detection device 80 according to the present embodiment differs from curling detection device 80 according to Embodiment 2 in that curling detection device 80 according to the present embodiment determines whether or not there is corner folding in sheet P, and when sheet P has corner folding, curling detection device 80 changes the calculation processing for evaluating the curling state from that in the case where sheet P does not have corner folding. Here, description of the configurations the same between the present embodiment and Embodiments 1 and 2 is omitted.

FIG. 12 is an explanatory view for explaining a curling evaluation method for sheet P in curling detection device 80 according to the present embodiment. For convenience of explanation, FIG. 12 illustrates the same read image as FIG. 7A.

In the curling evaluation method according to the present embodiment, curling evaluation section 83 first determines whether or not there is corner folding in sheet P based on the shape of edge region Le of sheet P, as in Embodiment 1. When sheet P does not have corner folding, curling evaluation section 83 sets, as evaluation-target width de, width de of sheet P at edge end Lee detected from the read image, and evaluates the curling state of sheet P by using, for example, the ratio between evaluation-target width de and reference width do (=de/dn) in the same manner as in Embodiment 1.

On the other hand, when sheet P has corner folding, curling evaluation section 83 evaluates the curling state of sheet P using the curling evaluation method of Embodiment 2. That is, in this case, curling evaluation section 83 sets an analysis point (point P1d in FIG. 12) to a position that is located on the side of the outer shape of sheet P extending along the conveyance direction and that is shifted by a predetermined amount from edge end Lee of sheet P toward the middle region Lm side. Then, evaluation-target width de is obtained from the coordinate of analysis point P1d in the width direction of sheet P.

However, if the curling evaluation method is applied as it is, the ratio (=de/dn) defining the curling amount is calculated to be smaller in the case where sheet P has corner folding than in the case where sheet P does not have corner folding. Thus, a common standard is required. In this respect, in the curling evaluating method according to the present embodiment, vertex position P1a′ of edge end Lee of sheet Pin the case where no shape change due to corner folding occurs in sheet P is estimated from the coordinates of analysis point P1d on the assumption that curling of sheet P occurs over entire curling region TL and a change in the image due to the curling is linear.

Specifically, letting the length of curling region TL in the x-axis direction be V2, the length from the base end position on the center side of sheet P to analysis point P1d in the x-axis direction be V1, and the positional deviation amount of the analysis point with respect to the reference outer shape of sheet P in the y-axis direction be f, positional deviation amount g in the y-axis direction at the position of edge end Lee of sheet P with respect to the reference outer shape of sheet P in the case where no shape change due to corner folding occurs in sheet P (that is, width de of sheet P at edge end Lee in the case where no shape change due to corner folding occurs in sheet P) is calculated based on the relationship of geometric similarity of triangles by the following equation:

$$\begin{matrix}[ 2 ] & \\ g = f \times \frac{{V}_{2}}{{V}_{1}} . & ( Equation 2 )\end{matrix}$$

Curling evaluation section 83 according to the present embodiment thus sets, as the evaluation-target width, width de of sheet P at edge end Lee in the case where no shape change due to corner folding occurs in sheet P. Then, curling evaluation section 83 evaluates the curling state of sheet P based on the ratio between evaluation-target width de and reference width dn of sheet P at edge end Lee (=de/dn).

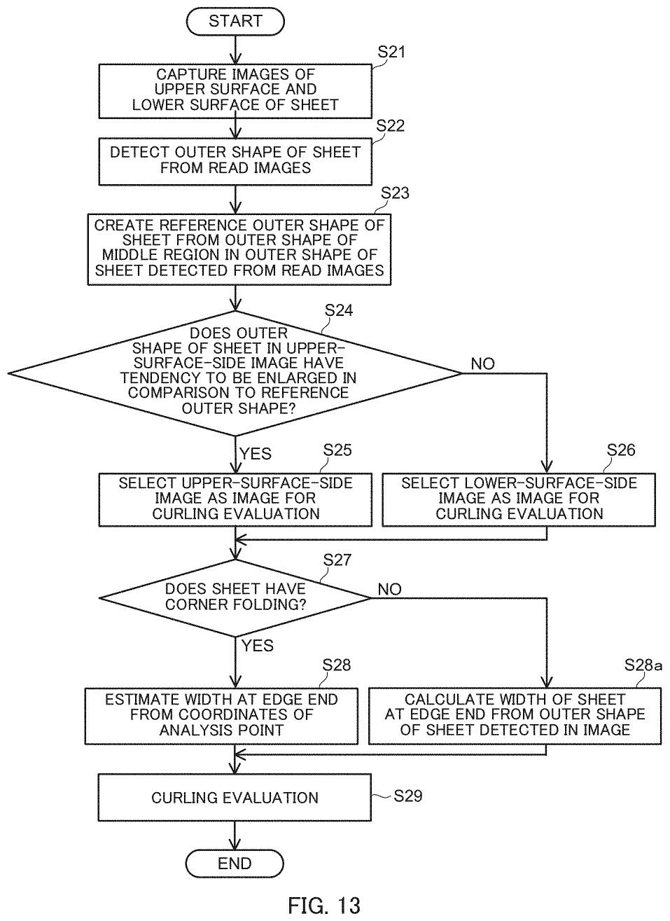

FIG. 13 illustrates an example of the operation of curling detection device 80 according to the present embodiment. Steps S21 to S26 are the same processes as steps 51 to S6 described above, and therefore description thereof is omitted.

At step S27, by using the image selected at step S25 or step S26, curling evaluation section 83 determines whether or not sheet P has corner folding. Here, when curling evaluation section 83 determines that sheet P has corner folding (step S27: YES), the process proceeds to step S28. On the other hand, when it is determined that there is no corner folding in sheet P (step S27: NO), curling evaluation section 83 proceeds to step S28a.

At step S28, curling evaluation section 83 sets analysis point P1d on the side of edge region Le of the outer shape of sheet P extending along the conveyance direction. Then, based on the coordinates at analysis point P1d on sheet P, using above Equation 2, curling evaluation section 83 obtains evaluation-target width de (here, width de of sheet P at edge end Lee in the case where no shape change due to corner folding occurs in sheet P) to be compared with reference width dn.

At step 528a, curling evaluation section 83 calculates width de of sheet P at edge end Lee based on the outer shape of sheet P detected in the image (here, the image selected at step S5 or step S6).

At step S29, curling evaluation section 83 evaluates the curling amount of sheet P by comparing width de of sheet P at edge end Lee with reference width dn of sheet P at edge end Lee.

At step S29, when there is no corner folding in sheet P, curling evaluation section 83 evaluates the curling amount of sheet P based on, for example, the ratio between width de of edge end Lee of the outer shape of sheet P obtained at step S28a and reference width dn of sheet P at edge end Lee. On the other hand, when sheet P has corner folding, curling evaluation section 83 evaluates the curling amount of sheet P based on the ratio between, on one hand, width de of edge end Lee of the outer shape of sheet P estimated at step S28 on the assumption that a shape change only due to the curling occurs and, on the other hand, reference width dn of sheet P at edge end Lee.

As described above, according to curling detection device 80 of the present embodiment, even when a shape change due to corner folding occurs, it is possible to evaluate the curling state of sheet P by a simpler method while reducing the influence of the shape change.

### Other Embodiments

The present invention is not limited to the above-described embodiments, and various modified aspects may be derived therefrom.

In the above embodiments, the method of estimating reference width dn from the outer shape of sheet P in middle region Lm detected in the read image has been described as an example of the method of setting reference width dn of sheet P used for the curling evaluation. However, the method of obtaining reference outer shape R1n and reference width dn of sheet P is not limited to this method. For example, when reference width dn of sheet P in edge region Le is known from the standards of sheet P used, reference width dn of sheet P may be set based on the standards of sheet P.

In addition, in the above embodiments, the correction processing for sheet P has been described as an example of the mode of using the evaluation result on the curling state of sheet P. However, the mode of using the evaluation result on the curling state of sheet P is not limited to the correction processing of sheet P For example, the evaluation result on the curling state of sheet P may be used for calibration processing, amending processing for image data to be printed on a succeeding sheet, and/or the like of image forming section 40 and/or fixing section 60.

In addition, in the above embodiments, the downstream side of fixing section 60 has been illustrated as an example of the position where curling detection device 80 is disposed. However, the position where curling detection device 80 is disposed is not limited to the downstream side of fixing section 60, and may be the upstream side of image forming section 40.

In addition, curling detection device 80 may have a function of reading an image formed for sheet Pin addition to the function of detecting the curling state of sheet P. In other words, curling detection device 80 may be used as an image reading device for reading the image formed for sheet P and calibrating the operation of image forming apparatus 1.

Although embodiments of the present invention have been described and illustrated in detail, the disclosed embodiments are made for purpose of illustration and example only and not limitation. The scope of the present invention should be interpreted by terms of the appended claims.

### INDUSTRIAL APPLICABILITY

According to the curling detection device of the present disclosure, even when corner folding occurs in a sheet, it is possible to evaluate the curling state of the sheet with high accuracy.

What is claimed is:

1. A curling detection device, comprising:
an imager that captures an image of a sheet conveyed; and
a hardware processor that detects an outer shape of the sheet in the image captured by the imager, and evaluates a curling state of the sheet while excluding a portion of the detected outer shape in which a change due to corner folding of the sheet is estimated to have occurred.

2. The curling detection device according to claim 1, wherein
the hardware processor sets an analysis point in the image on a side of the detected outer shape extending along a conveyance direction and in a region estimated not to include a shape change due to corner folding of the sheet, and calculates an evaluation-target width of the sheet in an edge region based on a coordinate of the analysis point, and
the hardware processor evaluates the curling state of the sheet based on a difference or a ratio between the evaluation-target width and a reference width of the sheet in the edge region in a case where no curling occurs.

3. The curling detection device according to claim 2, wherein
the hardware processor determines, based on a shape of the edge region in the outer shape, whether or not there is the corner folding in the sheet,
the hardware processor sets a width of the outer shape at an edge end as the evaluation-target width when the sheet does not have the corner folding, and,
when the sheet has the corner folding, the hardware processor estimates, based on the coordinate of the analysis point, the width of the sheet at the edge end in a case where a shape change only due to curling occurs, and sets the estimated width at the edge end as the evaluation-target width.

4. The curling detection device according to claim 3, wherein,
when the sheet has the corner folding, the hardware processor approximates, with a curve, a shape of the sheet in the case where the shape change only due to curling occurs, the hardware processor being configured to approximate the shape of the sheet based on coordinates of a plurality of the analysis points, and
the hardware processor sets, as the evaluation-target width, the width at the edge end estimated from the curve.

5. The curling detection device according to claim 3, wherein
the hardware processor searches each point on the side of the outer shape extending along the conveyance direction within the image, and determines whether or not there is the corner folding in the sheet, based on a positional deviation direction and a positional deviation amount in a width direction of the sheet between successive search points.

6. The curling detection device according to claim 2, wherein
the hardware processor calculates, as the evaluation-target width, a width of the outer shape obtained using the coordinate of the analysis point in the conveyance direction as a reference position.

7. The curling detection device according to claim 6, wherein
the hardware processor determines, based on a shape of the edge region in the detected outer shape, whether or not a position of the analysis point corresponds to a position including the shape change due to the corner folding, and excludes the sheet from an evaluation target when the position of the analysis point corresponds to the position including the shape change due to the corner folding.

8. The curling detection device according to claim 2, wherein
the hardware processor sets the reference width based on an outer shape of a middle region of the sheet in the detected outer shape.

9. The curling detection device according to claim 2, wherein
the hardware processor determines a curling direction of the sheet based on whether or not a width of the detected outer shape in the edge region is larger than the reference width.

10. The curling detection device according to claim 1, wherein
the hardware processor determines, based on an evaluation result on the curling state of the sheet, a correction amount for performing curling correction processing on the sheet.

11. The curling detection device according to claim 4, wherein
the hardware processor
sets, as a curling region in which the curling state occurs, a range of the sheet extending from an edge end position of the sheet toward a middle side of the sheet and corresponding to a distance between the imager and a conveyance roller of a conveyer adjacent to the imager, and
sets the coordinates of the plurality of analysis points in a part of the curling region in the outer shape where no shape change due to the corner folding is estimated.

12. The curling detection device according to claim 3, wherein
the hardware processor
sets, as a curling region in which the curling state occurs, a range of the sheet extending from an edge end position of the sheet toward a middle side of the sheet and corresponding to a distance between the imager and a conveyance roller of a conveyer adjacent to the imager, and
estimates the evaluation-target width based on a ratio between a distance to the analysis point from a base end position of the curling region located on the middle side of the sheet in the outer shape and a distance to an edge end position of the sheet from the base end position of the curling region in the outer shape, and based on the coordinate of the analysis point in a width direction of the sheet.

13. The curling detection device according to claim 6, wherein
the hardware processor sets the coordinate of the analysis point in the conveyance direction based on resolution of the image.

14. The curling detection device according to claim 1, wherein
the imager captures images of an upper surface side and a lower surface side of the sheet separately, and
the hardware processor
detects the outer shape of the sheet in each of an upper-surface-side image and a lower-surface-side image of the sheet generated by the imager, and
selects, as an image used to evaluate the curling state, one of the upper-surface-side image and the lower-surface-side image in which a width of the sheet in an edge region obtained from the outer shape has a tendency to be enlarged in comparison to a reference width of the sheet in the edge region.

15. An image forming apparatus, comprising:
the curling detection device according to claim 1.

16. A curling detection method, comprising:
a first process of capturing an image of a sheet conveyed; and
a second process of detecting an outer shape of the sheet in the image captured in the first process, and evaluating a curling state of the sheet while excluding a portion of the detected outer shape in which a change due to corner folding of the sheet is estimated to have occurred.
